(19) United States
(12) Patent Application Publication
(10) Pub. No.: US 2025/0296156 A1
(43) Pub. Date: Sep. 25, 2025

(54) MILLING CUTTER EQUIPMENT FOR ELEVATED FLOOR

(71) Applicant: VERO VERIA CORPORATION, Taipei (TW)

(72) Inventors: CHIEN-TEH HUANG, Taipei (TW); Shan-Hang Chen, Taipei (TW)

(21) Appl. No.: 18/814,692

(22) Filed: Aug. 26, 2024

(30) Foreign Application Priority Data
Mar. 22, 2024 (TW) 113110659

(51) Int. Cl. B23C 1/00; B23C 1/08

(52) U.S. Cl. CPC B23C 1/002; B23C 1/08

(57) ABSTRACT

The invention provides a milling cutter equipment for an elevated floor, which is used for milling a plurality of ejector pin structures on the back of the elevated floor. The milling cutter equipment includes a conveying device and a plurality of milling cutter ejector pin devices. The milling cutter ejector pin device includes an elevating device and a milling cutter set device. The milling cutter set device has a plurality of milling cutter bodies. By the use of the above mentioned devices, the conveying device carries the elevated floor and moves it above the elevating device. The elevating device then pushes the elevated floor away from the conveying device and is contacted against the milling cutter set device, and uses the milling cutter body to move it relative to the milling cutter set device and perform milling to the corresponding ejector pin structure.

### CROSS-REFERENCE TO RELATED APPLICATIONS

### Field of the Invention

This application claims priority to Taiwan Application Serial Number 113110659, filed Mar. 22, 2024, which is herein incorporated by reference in its entirety.

### BACKGROUND OF THE INVENTION

The invention relates to milling cutter equipment, in particular to a milling cutter equipment for elevated floor that can automatically mill the ejector pin structure for elevated floor.

### Description of the Prior Art

Today's elevated floors have been widely used in many places, such as anti-static heavy-duty machine rooms or dust-free rooms elevated floors made of aluminum alloy die-casting are produced through five main engineer processes including mold opening, aluminum melting, die-casting, forming and trimming.

However, most of the die casting elevated floors will have some remaining burrs. Therefore, during the installation process, the elevated floors are unable to fit closely together and unable to tightly fit between the platform frames on one hand, and it is also not beneficial to the installation, and there are certain risks and safety concerns exist on the other hand.

If the surfaces of the formed elevated floors are micro-processed manually, workers need to transport the elevated floors in batches to the corresponding processing locations and then perform processing operations. Not only will the production process be discontinuous, but the production efficiency will be low. And each processing requires maximum manpower and is time-consuming and labor-intensive.

If the surfaces of the formed elevated floors are micro-processed manually, workers need to transport the elevated floors in batches to the corresponding processing locations and then perform processing operations. Not only will the production process be discontinuous, but the production efficiency will be low. And each processing requires maximum manpower and is time-consuming and labor-intensive.

### SUMMARY OF THE INVENTION

The purpose of the invention is to provide milling cutter equipment for elevated floors. By arranging a plurality of sets of milling instruments into a plurality of milling cutter devices in a state that does not interfere with one another and combining with a way of an automatic process, one can perform milling operation to the ejector pin structures of the elevated floor respectively. In this way, the production schedule can be speeded up and production efficiency increase thereby reducing manpower requirement.

In order to achieve the above objectives, the invention provides a milling cutter equipment for elevated floors, including: a conveying device, a first milling cutter ejector pin device and a second milling cutter ejector pin device.

The conveying device includes a first frame, a second frame, and a transport structure. The transport structure, being positioned between the first frame and the second frame, performs a displacement movement and is capable of carrying a plurality of elevated floors,

The first milling cutter ejector pin device, being positioned between the first frame and the second frame and make the transport structure passes the first milling cutter ejector pin device. The first milling cutter ejector pin device includes a first elevating device and a first milling cutter set device.

The first elevating device includes four corner fixed pieces. which fix the four corners of the elevated floor respectively and push the elevated floor away from the transport structure and at a distance of a first height apart.

The first milling cutter set device, being located at a position corresponding to the first elevating device, has a plurality of first milling cutter bodies that do not interfere with one another and are divided into several sets of barrel diameter in according with the height of the ribs.

The second milling cutter ejector pin device, being positioned between the first milling cutter ejector pin device and the second frame, allows the transport structure to pass through the second milling cutter ejector pin device. The second milling cutter ejector pin device includes: a second elevating device and a second milling cutter set device.

The second elevating device includes four corner fixed pieces which fix the four corners of the elevated floor respectively and push the elevated floor away from the transport structure at a distance of a second height apart.

The second milling cutter set device, being located at a position corresponding to the second elevating device, has a plurality of second milling cutter bodies that do not interfere with one another and are divided into several sets of barrel diameter in according with the height of the ribs.

Furthermore, the conveying structure includes a main frame, a chain set, a first gear set and a second gear set. Both ends of the main frame are connected to the first gear set and the second gear set respectively. The chain set is connected to the first gear set and the second gear set respectively so that when the first gear set and the second gear set rotate synchronously, the chain set performs the displacement movement.

Furthermore, the chain set includes a guide strip and a chain. The guide strip is provided at the two opposite outer edges of the main frame. A bearing portion of the chain performs the displacement movement along a guide groove of the guide strip. In the mean time, a roller and a shaft of the chain rolls respectively on a sliding surface of the guide strip to perform the displacement movement.

In addition, the conveying device further includes a motor installed on the second frame, and the motor is connected to the second gear set to make the second gear set to perform rotation.

Furthermore, in a preferred embodiment, the milling cutter equipment for elevated floor further include a third milling cutter ejector pin device, which being positioned between the second milling cutter ejector pin device and the second frame, can make the transport structure passes through the third milling cutter ejector pin device. The third milling cutter ejector pin device includes a third elevating device and a third milling cutter set device.

The third elevating device includes four corner fixed pieces which fix the four corners of the elevated floor respectively and push the elevated floor away from the transport structure and at a spacing of a third height apart.

The third milling cutter set device, being located at a position corresponding to the third elevating device, has a plurality of third milling cutter bodies that do not interfere with one another and are divided into several sets of barrel diameter in according with the height of the ejector pin. A plurality of the third milling cutter bodies and a plurality of the second milling cutter bodies as well as a plurality of the first milling cutter bodies are corresponding to a plurality of different locations of the ejector pin respectively.

Furthermore, in a preferred embodiment, the milling cutter equipment for elevated floor further include a fourth milling cutter ejector pin device, which is positioned between the third milling cutter ejector pin device and the second frame, can make the transport structure passes through the fourth milling cutter ejector pin device. The fourth milling cutter ejector pin device includes a fourth elevating device and a fourth milling cutter set device.

The fourth elevating device includes four corner fixed pieces which fix the four corners of the elevated floor respectively and support the elevated floor away from the transport structure and at a spacing of a fourth height apart.

The fourth milling cutter set device, being located at a position corresponding to the fourth elevating device, has a plurality of fourth milling cutter bodies that do not interfere with one another and are divided into several sets of barrel diameter in according with the height of the ejector pin. A plurality of the fourth milling cutter bodies, a plurality of the third milling cutter bodies, a plurality of the second milling cutter bodies, and a plurality of the first milling cutter bodies are corresponding to a plurality of different locations of the ejector pin respectively.

In a preferred embodiment, further, the first milling cutter ejector pin device further includes a first pedestal, a first frame body, a first fixed plate and a first conveying device.

The first pedestal s the first elevating device.

Both ends of the first frame body are connected to the first pedestal and the first milling cutter set device respectively. The first frame body has a first groove which provides the first elevating device to pass through.

The first fixed plate, having a plurality of first perforations, is separated from the first frame body by a first spacing. The first perforations provide the first milling cutter body to pass through. The first milling cutter body is connected to the first fixed plate with a first fixed ring.

The first transport device is connected to a plurality of the first milling cutter bodies respectively making the first milling cutter bodies to perform rotating operation.

In a preferred embodiment, further, the second milling cutter ejector pin device further includes a second pedestal, a second frame body, a second fixed plate and a second transport device.

The second pedestal s the second elevating device.

Both ends of the second frame body are connected to the second pedestal and the second milling cutter set device respectively. The second frame body has a second groove which provides the second elevating device to pass through.

The second fixed plate, having a plurality of second perforations, is separated from the second frame body by a second spacing. The second perforations provide the second milling cutter body to pass through. The second milling cutter body is connected to the second fixed plate with a second fixed ring.

The second conveying device is connected to a plurality of the second milling cutter bodies respectively making the second milling cutter bodies to perform rotating operation.

In a preferred embodiment, further, the third milling cutter ejector pin device further includes a third pedestal, a third frame body, a third fixed plate and a third transport device.

The third pedestal carries the third elevating device.

Both ends of the third frame body are connected to the third pedestal and the third milling cutter set device respectively. The third frame body has a third groove which provides the third elevating device to pass through.

The third fixed plate is separated from the third frame body by a third spacing. The third fixed plate has a plurality of third perforations. The third perforations make the third milling cutter body to pass through. The third milling cutter body is connected to the third fixed plate with a third fixed ring.

The third transport device is connected to a plurality of the third milling cutter bodies making the third milling cutter bodies perform rotating operation.

In a preferred embodiment, further, the fourth milling cutter ejector pin device further includes: a third pedestal, a fourth frame body, a fourth fixed plate and a third transport device.

The fourth pedestal carries the fourth elevating device.

Both ends of the fourth frame body are connected to the fourth pedestal and the fourth milling cutter set device respectively. The fourth frame body has a fourth groove providing the fourth elevating device to pass through.

The fourth fixed plate is separated from the fourth frame body by a fourth spacing. The fourth fixed plate has a plurality of fourth perforations that make the fourth milling cutter body to pass through. The fourth milling cutter body is connected to the fourth fixed plate with a fourth fixed ring.

The fourth transport device is connected to a plurality of fourth milling cutter bodies respectively making the fourth milling cutter bodies perform rotating operation.

In a preferred embodiment, further, the first milling cutter body, the second milling cutter body, the third milling cutter body and the fourth milling cutter body are actuated by a control device, and the control device is either a hydraulic control device or a pneumatic control device.

In a preferred embodiment, the first frame, the second frame, the third frame and the fourth frame further include two buckles and a plurality of fine-tuning devices respectively.

Further, the milling cutter equipment for elevated floo further includes a human-machine interface control platform. The human-machine interface control platform and the transport device, the first milling cutter ejector pin device, the second milling cutter ejector pin device, and the third milling cutter ejector pin device, the fourth milling cutter ejector pin device as well as the control device are all in mutually electrical and communicative connection to control the operation of the milling cutter equipment for elevated floo.

In a preferred embodiment, each elevating device includes a first link device, a second link device and a plurality of corner fixed pieces, wherein two of the corner fixed pieces are provided above the first link device and the second link device respectively. The first link device and the second link device are on both sides of the first elevating device respectively. By use of a plurality of round tubes to connect the first link device and the second link device, together with using a pneumatic device or a hydraulic device to push one of the round tubes, further driving the first link device and the second link device to rise or lower synchronously to push the elevated floor away from the conveying structure.

In a preferred embodiment, each milling cutter body includes a synchronous wheel, a spline, a push rod, a spindle, a sleeve and a milling cutter wherein the push rod has a first accommodation space, the spindle is positioned in the first accommodation space, the sleeve is a hollow structure and is movably connected to the spline, the milling cutter is connected to the spindle, and the milling cutter is positioned in the sleeve, and the synchronous wheel drives the spline to perform rotation.

In a preferred embodiment, each frame body also includes two buckles and a plurality of fine-tuning devices. The two buckles are provided at the two opposite sides of the groove of the adjacent frame body respectively wherein the two opposite sides are positioned in the direction of the displacement. In addition, a plurality of the fine-tuning devices are provided at a equal spacing on the other two opposite sides of the groove respectively

Therefore, by the use of milling cutter equipment for elevated floor provided by the invention, one can perform milling operation of the elevated floor through the set up of a plurality of milling cutter sets in a state of non-interference with one another, and combining the way of the automatic flowing process formed by the conveying device to perform milling operation of the ejector pin of the elevated floor respectively so as to speed up the production process and improve production efficiency while reducing the requirements of human resource.

### BRIEF DESCRIPTION OF THE DRAWING

In order to make the above and other purposes, features, advantages and embodiments of the invention easy to understand, the attached drawings are explained as follows:

FIG. 1 is a schematic three-dimensional structural diagram of the first embodiment of the invention.

FIG. 2 is a schematic three-dimensional view of the elevated floor according to the first embodiment of the invention.

FIG. 3 is a schematic three-dimensional view of the elevated floor according to the first embodiment of the invention from another perspective.

FIG. 4 is a schematic structural diagram of the transport structure in the first embodiment of the invention.

FIG. 5A is an exploded schematic diagram of the transport structure in the first embodiment of the invention.

FIG. 5B is an exploded schematic diagram of the chain set in the first embodiment of the invention.

FIG. 6 is a schematic structural diagram of the first milling cutter ejector pin device in the first embodiment of the invention.

FIG. 7 is an exploded schematic diagram of the first milling cutter ejector pin device in the first embodiment of the invention.

FIG. 8 is a schematic structural diagram of the second milling cutter ejector pin device in the first embodiment of the invention.

FIG. 9 is an exploded schematic diagram of the second milling cutter ejector pin device in the first embodiment of the invention.

FIG. 10 is a schematic structural diagram of the third milling cutter ejector pin device in the first embodiment of the invention.

FIG. 11 is an exploded schematic diagram of the third milling cutter ejector pin device in the first embodiment of the invention.

FIG. 12 is a schematic structural diagram of the fourth milling cutter ejector pin device in the first embodiment of the invention.

FIG. 13 is an exploded schematic diagram of the fourth milling cutter ejector pin device in the first embodiment of the invention.

FIG. 14 is a schematic structural diagram of the fifth milling cutter ejector pin device in the second embodiment of the invention.

FIG. 15 is an exploded schematic diagram of the fifth milling cutter ejector pin device in the second embodiment of the invention.

FIG. 16 is a schematic three-dimensional structural diagram of the second embodiment of the invention.

FIG. 17 is a partial cross-sectional view of the fifth milling cutter body in the second embodiment of the invention.

FIG. 18 is a schematic structural diagram of the fifth milling cutter body in the second embodiment of the invention.

### DETAILED DESCRIPTION OF THE PREFERRED EMBODIMENT

According to usual working methods, the various features and components in the Fig. are not drawn to actual scale. They are drawn in order to best present the specific features and components related to the invention. In addition, between different drawings, the same or similar element symbols are used to refer to similar elements and components.

The above description is only an overview of the technical solution of the invention. In order to have a clearer understanding of the technical means of the invention, it can be implemented in accordance with the content of the instructions, and in order to achieve the above and other purposes, features and advantages of the invention, To make it more obvious and easy to understand, the following is a detailed description of the preferred embodiment along with the accompanying drawings.

The following disclosure provides different embodiments, or examples, to achieve different features of the provided subject matter. The specific examples of components and arrangements described below are for simplifying the present disclosure and are not intended to be limiting; the size and shape of the components are not limited by the disclosed range or numerical value, but may depend on the process conditions of the components or the required requirements, characteristic. For example, various diagrams and cross-sectional views are used to describe the technical features of the invention, and these cross-sectional views are schematic diagrams of idealized embodiments. Therefore, variations in the shapes shown in the illustrations due to manufacturing processes and/or tolerances are to be expected and should not be limited thereby. In the mean time,, in this manual, words such as “upper”, “lower”, “front”, “back”, “left”, “right”, “first”, “second”, “third”, “third” are used. Terms such as “four” and “one” are only used to facilitate the clarity of description and are not used to limit the scope of the implementation of the invention. Changes or adjustments in their relative relationships shall also be regarded as without substantial changes in the technical content. This is the scope within which the invention can be implemented.

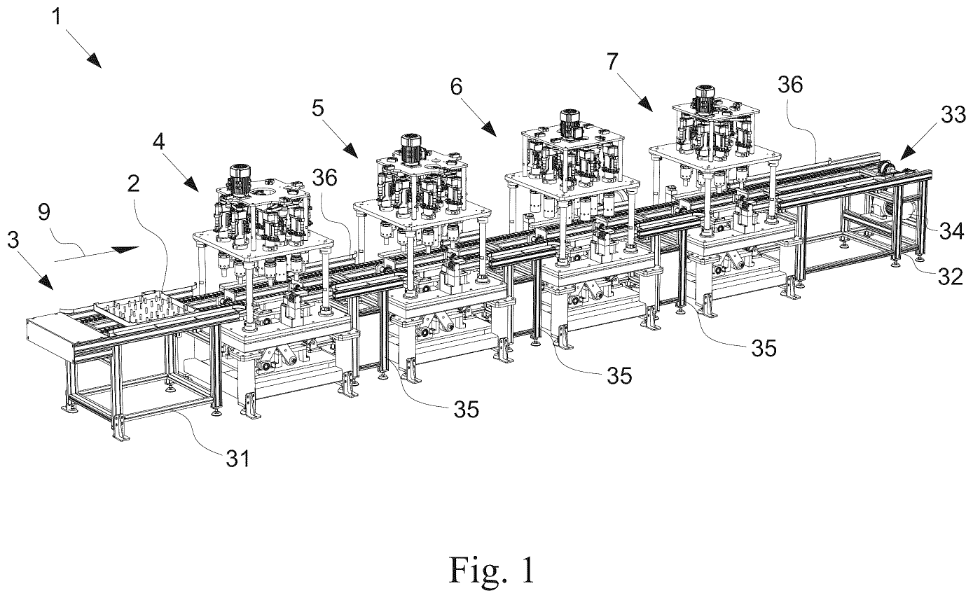

Referring to FIG. 1 through 3, which provide a first embodiment of milling cutter equipment for elevated floor 1, which includes: a conveying device 3, a first milling cutter ejector pin device 4, a second milling cutter ejector pin devices 5, a third milling cutter ejector pin device 6 and a fourth milling cutter ejector pin device 7. It should be noted that this embodiment uses four sets of milling cutter ejector pin devices as an example for the following description, but it is not limited thereto.

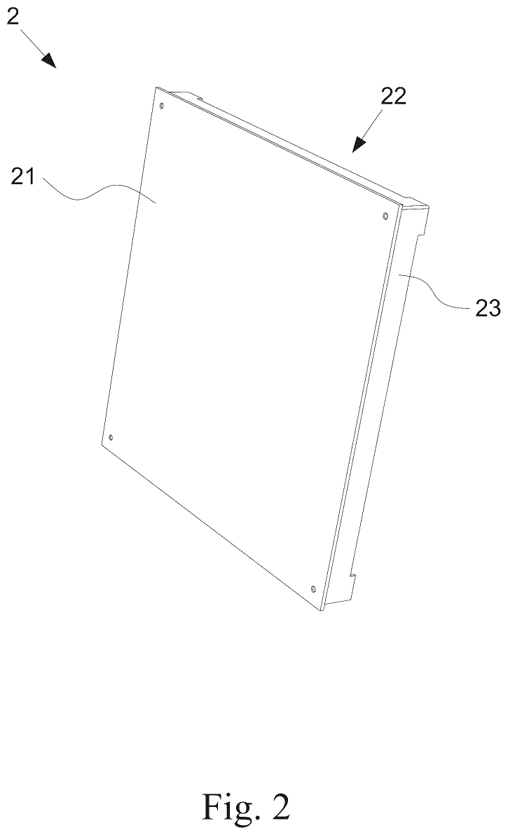

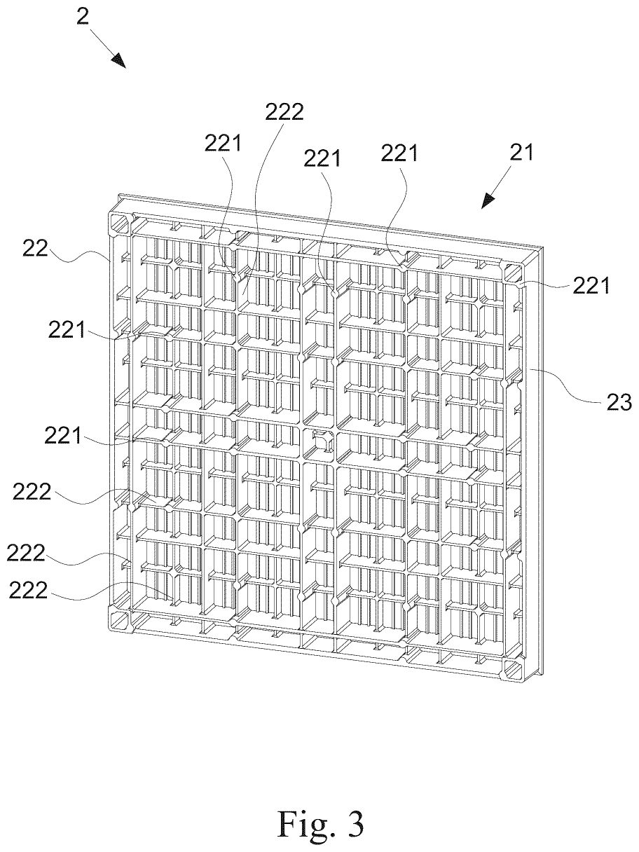

The elevated floors developed by the applicant are divided into light, standard, comprehensive and heavy duty type pedestal on the height of the ribs. There are more than 9 types of elevated floors in total. The example shown in this preferred embodiment is one of the elevated floors 2, as shown in two three-dimensional schematic diagrams in FIG. 2 and FIG. 3, the elevated floor 2 is used to carry heavier loads, and its carrying load is about 3000 kilograms,

The elevated floor 2, being rectangular in shape, has a first surface 21 and a opposite second surface 22 as well as a side 23 connecting the first surface 21 and the second surface 22. The elevated floor 2 has a plurality of ejector pins 221 and a plurality of honeycomb-shaped ribs 222. The ribs 222 are positioned on of a plurality of the ribs 222. It should be noted that a plurality of ejector pins 221 are at the intersection of the ribs 222. The ribs 222 has different heights and the ejector pins 221 are divided into several sets of heights.

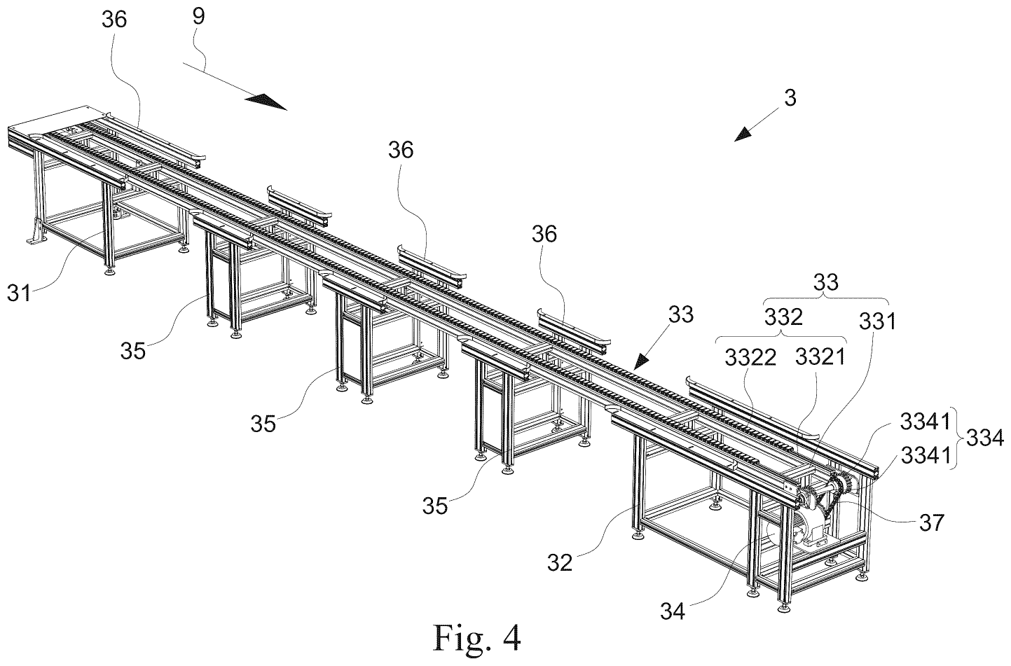

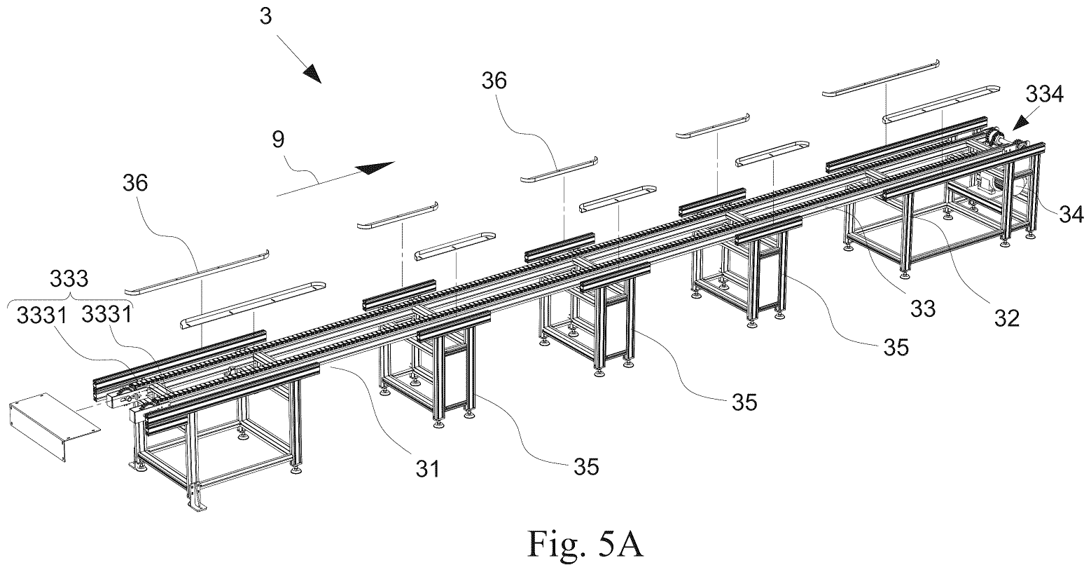

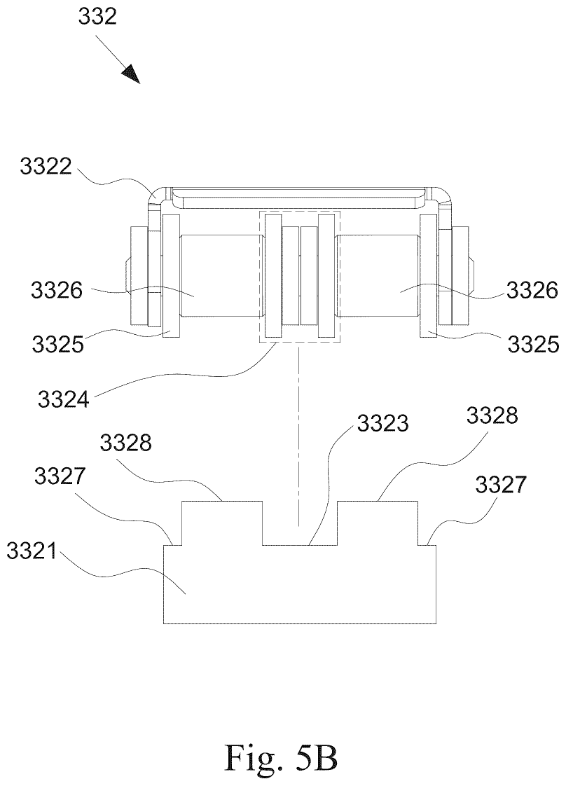

Referring to FIG. 4, FIG. 5A and FIG. 5B. The conveying device 3 includes a first frame 31, a second frame 32 and a transport structure 33. The transport structure 33 is positioned between the first frame 31 and the second frame 32 and the transport structure 33 performs a displacement movement 9, that is to say, the transport structure 33 can carry a plurality of the elevated floors 2 and move the elevated floors 2 from the first frame 31 to the second frame 32.

The transport structure 33 includes a main frame 331, a chain set 332, a first gear set 333 and a second gear set 334. Both ends of the main frame 331 are connected to the first gear set 333 and the second gear set 334 respectively. The chain set 332 is connected to the first gear set 333 and the second gear set 334 respectively. In this way, when the first gear set 333 and the second gear set 334 rotate synchronously, the chain set 332 performs the displacement movement 9.

In this first embodiment, the first gear set 333 can be composed of two first sub-gear sets 3331 that are provided at both ends of the main frame 331. The second gear set 334, being provided at the other end of the first gear set 331, is composed of two interlinked second sub-gear sets 3341.

Furthermore, the chain set 332 includes a guide strip 3321 and a chain 3322. The guide strip 3321, being provided at the edge on the two opposite outer sides of the main frame 331, has a guide groove 3323 and two sliding surfaces (3327, 3328). The chain 3322 having a bearing portion 3324 on one side, further includes a roller 3325 and a shaft 3326. The bearing portion 3324 performs the displacement movement 9 along the guide groove 3323, and in the mean time, the roller 3325 and the two shaft 3326 rolls on the sliding surfaces (3327, 3328) respectively to perform the displacement movement 9 of the elevated floor 2.

In addition, the conveying device 3 further includes a motor 34, which being provided on the second frame 32, is connected to the second gear set 334 through a driving chain 37, so that the motor 34 drives the second gear set 334 to perform rotation. In the mean time, the motor 34 drive the first gear set 333 through the chain set 332 to make the first gear set 333 and the second gear set 334 rotate synchronously so that the conveying device 3 carries a plurality of the elevated floors 2 to perform displacement movement 9, but is not limited to this.

In addition, in a preferred embodiment, the conveying device 3 also includes at least one support frame 35 and a plurality of position-limiting edge strips 36. The support frames 35 are provided between the first frame 31 and the second frame 32 and are provided at equal distance while supporting the transport structure 33. The position-limiting edge strips 36 are provided on the first frame 31, the second frame 32 and the support frame 35. Through the set up of the position-limiting edge strips 36, when the elevated floor 2 performs the displacement movement 9, the elevated floor 2 can normally move on the conveying device 3.

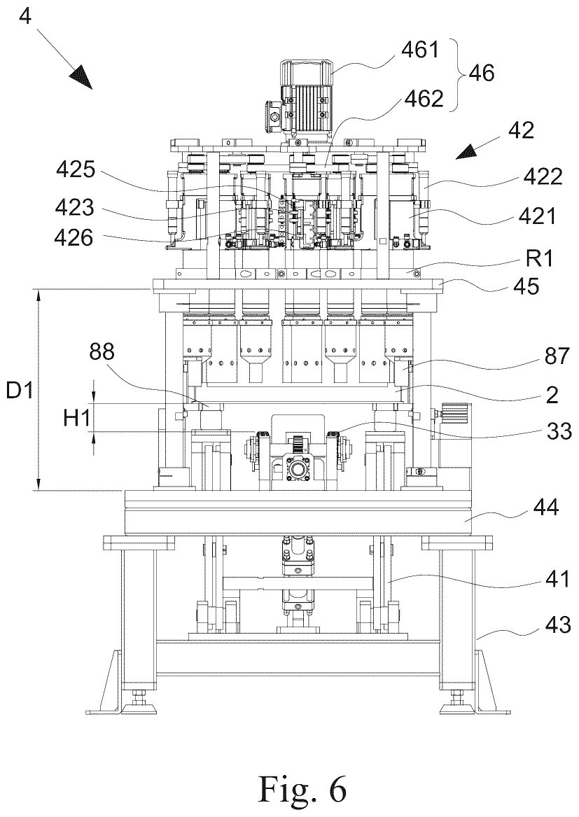

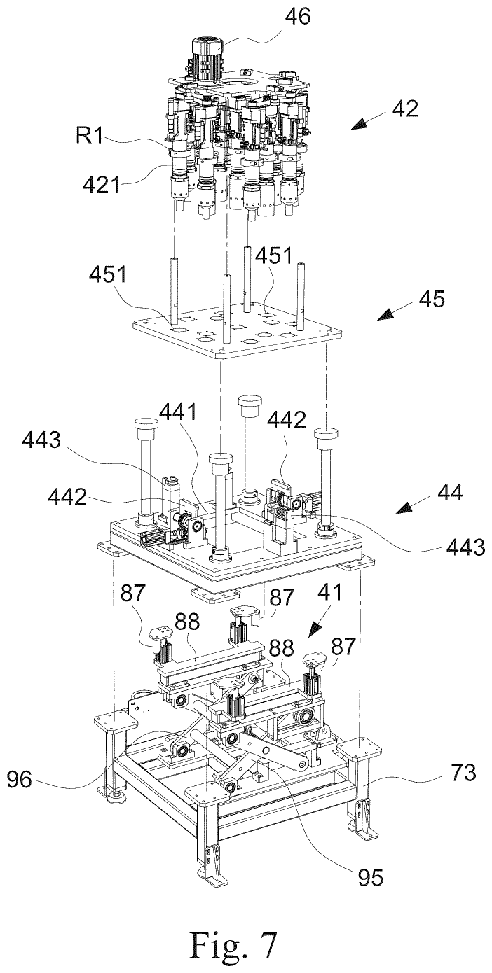

Referring to FIG. 6 and FIG. 7. The first milling cutter ejector pin device 4 is positioned between the first frame 31 and the second frame 32, and the transport structure 33 passes through the first milling cutter ejector pin device 4. The first milling cutter ejector pin device 4 includes a first elevating device 41, a first milling cutter set device 42, a first pedestal 43, a first frame body 44, a first fixed plate 45 and a first transmission device 46.

The first elevating device 41 includes a first link device 95, a second link device 96 and a plurality of corner fixed pieces 87. Two of corner fixed pieces 87 are provided above the first link device 95 and the second link device 96 respectively. The first link device 95 and the second link device 96 are on both sides of the first elevating device 41 respectively. By the use of a plurality of round tubes to connect the first link device 95 and the second link device 96, and by the use of a pneumatic device or a hydraulic device (not shown in the Fig.) to push one of the round tubes, thereby to drive to raise or lower the first link device 95 and the second link device 96 synchronously so as to push the elevated floor 2 away apart from the transport structure 33 with a spacing of the first height H1.

The first milling cutter set device 42 is located at a position corresponding to the first elevating device 41 and has a plurality of first milling cutter bodies 421. A plurality of first milling cutter bodies 421 do not interfere with one another A plurality of the milling cutter bodies 421 are divided into several sets of barrel diameter according to the height of the ejector pin 221.

The first pedestal 43 carries the first elevating device 41.

Both ends of the first frame body 44 are respectively connected to the first pedestal 43 and the first milling cutter set device 42. The first frame body 44 has a first groove 441, and the first groove 441 provides The first elevating device 41 passes.

In addition, in the first embodiment, the first frame 44 also includes two first buckles 442 and a plurality of first fine-tuning devices 443. The first buckles 442 are arranged on the first frame. On the body 44 and adjacent to the two opposite sides of the first groove 441 in the direction of travel of the displacement movement 9, the first fine-tuning device 443 is provided in equal spacing on the other two opposite sides of the first groove 441.

It should be noted in addition that when the elevated floor 2 is conveyed above the first groove 441, the first buckle 442 that is far away from the elevated floor 2 is flipped to the direction of travel 9 In mutually perpendicular directions, the stop is on one side of the elevated floor 2. In the mean time, the other first buckle 442 is turned over and stops on the other side of the elevated floor 2 to position the elevated floor 2. Finally, so that A support plate 88 of the first elevating device 41 supports the elevated floor 2 away from the transport structure 33 and away from the first height H1. Preferably, the position of the elevated floor 2 is finely adjusted by the first fine-tuning device 443. At a predetermined position, use a plurality of corner fixed pieces 87 to fix the elevated floor 2, loosen two of the first buckles 442 and a plurality of the first fine-tuning devices 443, and then be raised by the first elevating device 41, so that the elevated floor 2 leaves the conveying 3 for processing.

The first fixed plate 45 is separated from the first frame body 44 by a first spacing D1. The first fixed plate 45 has a plurality of first perforations 451. The first perforations 451 provide the first milling cutter body 421. Through, the first milling cutter body 421 is connected to the first fixed plate 45 with a first fixed ring R1, and the first milling cutter body 421 can be connected with a damper 422, a stroke adjuster 423, and a first stroke Contactor 425 and a second stroke contactor 426. The plurality of first perforations 451 are evenly distributed on the first fixed plate 45 and relative to the position of the ejector pin 221. In addition, among the plurality of first perforations 451, the center spacing of the two adjacent first perforations 451 is greater than the diameter of the first milling cutter body 421.

The first transmission device 46 is connected to a plurality of the first milling cutter bodies 421 respectively to make the first milling cutter bodies 421 perform rotation. It should be noted that the first transmission device 46 includes a first power source 461 and a plurality of first belt sets 462. Through the supplying of power by the first power source 461, a plurality of first belt sets 462 can be mutually connected to perform rotation.

To further explain, the elevated floor 2 is placed on the conveying device 3, and the transport structure 33 carries the elevated floor 2 to perform conveying work. The elevated floor 2 is displaced above the first elevating device 41, and by the use of the first elevating device 41, the elevated floor 2 is pushed away from the transport structure 33 from the first surface 21. The elevated floor 2 has a spacing of the first height H1 apart from the transport structure 33. In the mean time, the ribs 222 contact at one end of the milling cutter set device 42.

That is to say, since the first milling cutter set device 42 is located at a position corresponding to the position of the first elevating device 41, the first elevating device 41 is used to push the elevated floor 2 away from the transport structure 33 so that the ribs 222 of different heights contact against the corresponding first milling cutter body 421 respectively, and the first milling cutter body 421 can perform milling operations on the corresponding ejector pins 221.

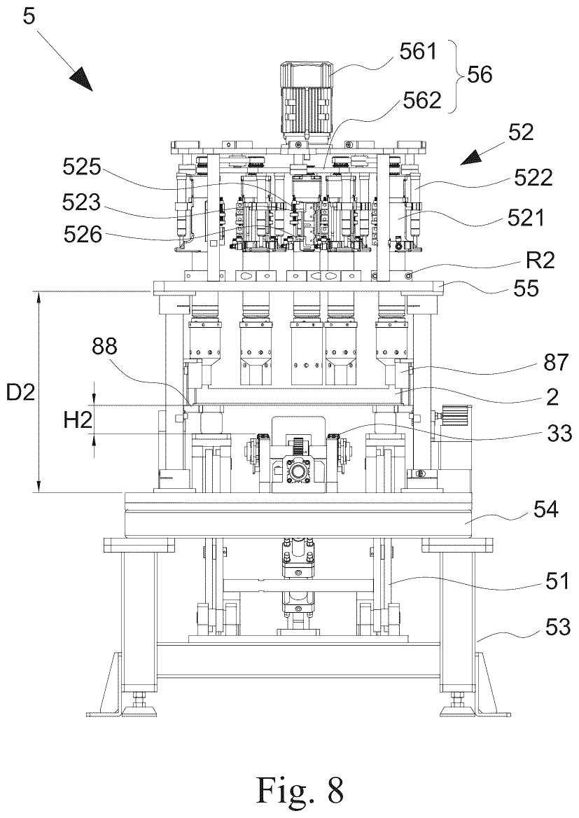

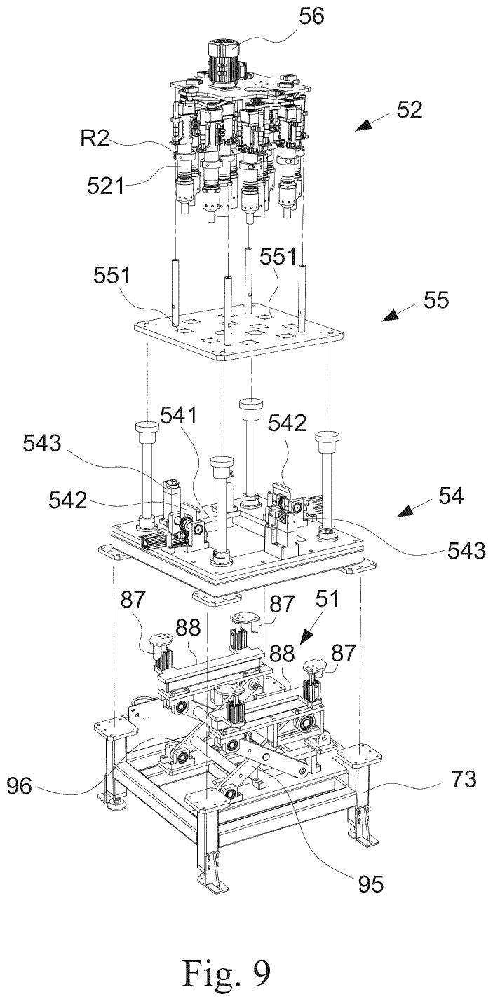

Referring to FIG. 8 and FIG. 9. The second milling cutter ejector pin device 5 is positioned between the first milling cutter ejector pin device 4 and the second frame 32, and the transport structure 33 passes through the second milling cutter ejector pin device 5. The second milling cutter ejector pin device 5 includes a second elevating device 51, a second milling cutter set device 52, a second pedestal 53, a second frame body 54, a second fixed plate 55 and a second transmission devices 56.

The second elevating device 51 includes a first link device 95, a second link device 96 and a plurality of corner fixed pieces 87 where two of the corner fixed pieces 87 are provided on the first link device 95 and the second link device 96 respectively. The first link device 95 and the second link device 96 are on both sides of the second elevating device 51 respectively. By the use of a plurality of round tubes to connect the first link device 95 and the second link device 96, and a pneumatic device or a hydraulic device (not shown in the Fig.) pushes one of the round tubes, thereby drives the first link device 95 and the second link device 96 to raise or lower synchronously so as to push the elevated floor 2 away from the transport structure 33 and have a spacing of the second height H2 apart. The second height H2 and the first height H1 may be the same or different.

The second milling cutter set device 52, being located at a position corresponding to the second elevating device 51, has a plurality of second milling cutter bodies 521 which do not interfere with one another A plurality of second milling cutter bodies 521 are also divided into several sets of barrel diameters according to the heights of the ejector pins 221. Also a plurality of second milling cutter bodies 521 and the plurality of first milling cutter bodies 421 correspond to a plurality of different positions of the ejector pins 221 respectively.

The second pedestal 53 carries the second elevating device 51.

Both ends of the second frame body 54, being connected to the second pedestal 53 and the second milling cutter set device 52 respectively, has a second groove 541 that provides the second elevating device 51 to pass though.

In addition, in the first embodiment, the second frame body 54 also includes two second buckles 542 and a plurality of second fine-tuning devices 543. The second buckle 542, being provided on the second frame 54, is contacted the adjacent two opposite sides of the second groove 541 in the traveling direction 9 while the second fine-tuning device 543 is provided on the other two opposite sides of the second groove 541.

What is needed to explain in addition is that when the elevated floor 2 is conveyed above the second groove 541, the second buckle 542, being positioned far away from the elevated floor 2, is flipped to the mutually perpendicular directions of travel 9 and stop on one side of the elevated floor 2. In the meantime, the other second buckle 542 is flipped to stops on the other side of the elevated floor 2 to position the elevated floor 2 and finally to make a support plate 88 of the second elevating device 51 pushes the elevated floor 2 away from the transport structure 33 with a spacing of the second height H2 apart. Preferably, by the use of the second fine-tuning device 543, the elevated floor 2 is fine-tuned to a predetermined position. A plurality of the corner fixed pieces 87 are used again to fix the elevated floor 2 and to loose two of the second buckle 542 and a plurality of the second fine-tuning device 543 and the second elevating device 51 is raised again making the elevated floor 2 leave the conveying device 3 to perform processing.

The second fixed plate 55 and the second frame body 54 are a second spacing D2 apart. The second spacing D2 and the first spacing D1 may be the same or different. The second fixed plate 55 has a plurality of the second perforations 551 that provides the second milling cutter body 521 to pass through. The second milling cutter body 521 is connected to the second fixed plate 55 with a second fixed ring R2. The second milling cutter body 521 can be connected with a damper 522, a stroke adjuster 523, a first stroke contactor 525 and a second stroke contactor 526. A plurality of second perforations 551 are evenly distributed on the second fixed plate 55 and relative to the position of the ejector pin 221. In addition, among the plurality of second perforations 551, the spacing between the centers of two adjacent second perforations 551 is greater than the diameter of the second milling cutter body 521.

The second transmission device 56 is connected to a plurality of second milling cutter bodies 521 respectively, to make the second milling cutter bodies 521 to perform rotation. It should be noted that the second transmission device 56 includes a second power source 561 and a plurality of second belt sets 562. Through the supplying of power by the first power source 561, a plurality of second belt sets 562 can be mutually connected to perform rotation.

To further explain, the elevated floor 2 is displaced above the second elevating device 51, and the elevated floor 2 is pushed away from the transport structure 33 from the first surface 21 through the second elevating device 51. The elevated floor 2 is displaced from the transport structure 33 to the second height H2 apart, and in the mean time, the ribs 222 contact against one end of the second milling cutter set device 52.

That is to say, since the second milling cutter set device 52 is located at a position corresponding to the second elevating device 51, the elevated floor 2 is pushed away from the transport structure 33 from the first surface 21 by the use of the second elevating device 51 making the ribs 222 of different heights contact against the corresponding second milling cutter body 521 respectively, so that the second milling cutter body 521 can perform milling operations against the corresponding ejector pins 221. In addition, the plurality of second milling cutter bodies 521 and the plurality of first milling cutter bodies 421 correspond to a plurality of different positions of the ejector pins 221 respectively.

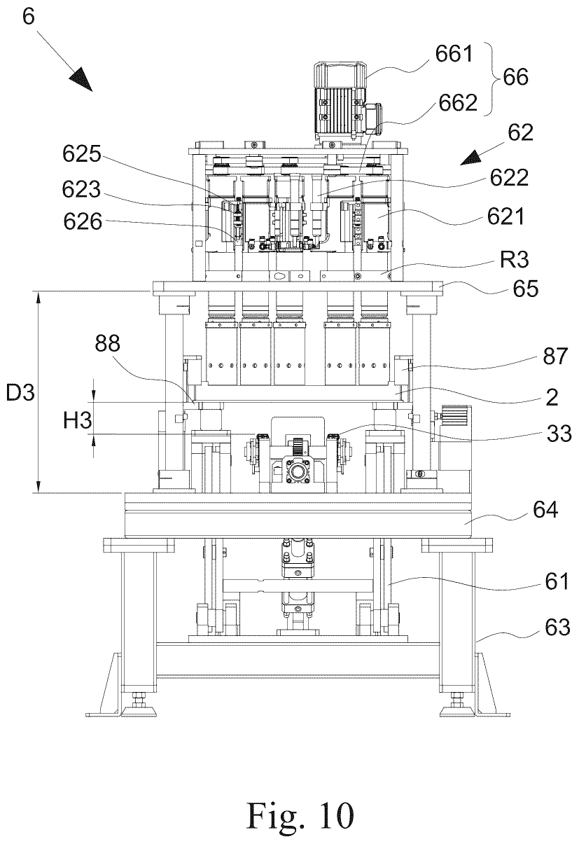

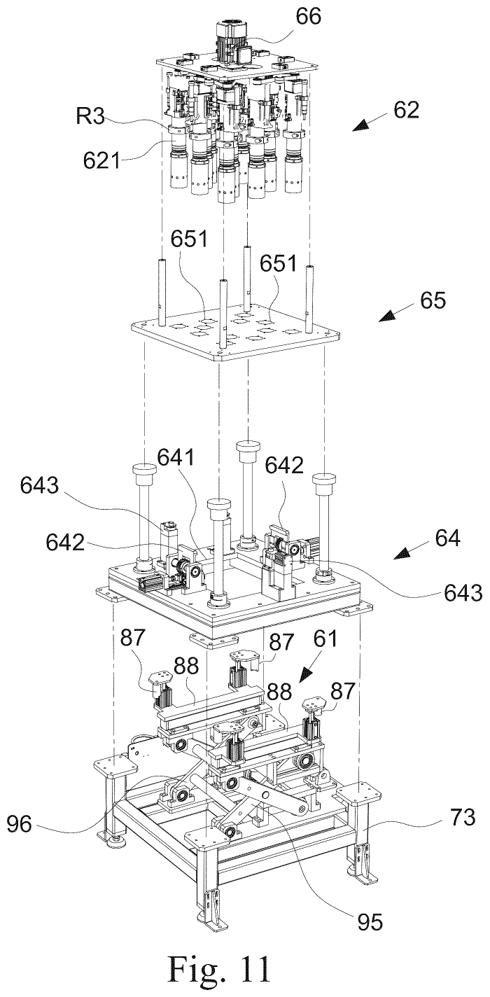

Referring to FIG. 10 and FIG. 11 for additional information. The third milling cutter ejector pin device 6 is positioned between the second milling cutter ejector pin device 5 and the second frame 32, and the transport structure 33 passes through the third milling cutter ejector pin device 6. The third milling cutter ejector pin device 6 includes a third elevating device 61, a third milling cutter set device 62, a third pedestal 63, a third frame body 64, a third fixed plate 65 and a third transmission device 66.

Referring to FIG. 10 and FIG. 11 for additional information. The third milling cutter ejector pin device 6 is positioned between the second milling cutter ejector pin device 5 and the second frame 32, and the transport structure 33 passes through the third milling cutter ejector pin device 6. The third milling cutter ejector pin device 6 includes a third elevating device 61, a third milling cutter set device 62, a third pedestal 63, a third frame body 64, a third fixed plate 65 and a third transmission device 66.

The third milling cutter set device 62 being located at a position corresponding to the third elevating device 61, has a plurality of third milling cutter bodies 621 that do not interfere with one another and are divided into several sets of barrel diameters according to the height of the ejector pin 221. Further, a plurality of third milling cutter bodies 621 correspond to different positions of the ejector pins 221 of the plurality of second milling cutter bodies 521 and a plurality of the first milling cutter bodies 421 respectively.

The third pedestal 63 carries the third elevating device 61.

The third frame body 64, having its both ends connected to the third pedestal 63 and the third milling cutter set device 62 respectively, has a third groove 641 that provides the third elevating device 61 to pass through.

In addition, in the first embodiment, the third frame body 64 also includes two third buckles 642 and a plurality of third fine-tuning devices 643. The third buckles 642 are provided on the third frame body 64 and are contacted adjacent to the two opposite sides of the third groove 641 in the traveling direction of the displacement movement 9. The third fine-tuning device 643 is in equal spacing provided on the other two opposite sides of the third groove 641.

What is needed to explain in addition is that when the elevated floor 2 is conveyed above the third groove 641, the third buckle 642, being positioned far away from the elevated floor 2, is flipped to the mutually perpendicular directions of travel 9 and stop on one side of the elevated floor 2. In the meantime, the other third buckle 642 is flipped to stops on the other side of the elevated floor 2 to position the elevated floor 2 and finally to make a support plate 88 of the third elevating device 61 pushes the elevated floor 2 away from the transport structure 33 with a spacing of the second height H2 apart. Preferably, by the use of the third fine-tuning device 643, the elevated floor 2 is fine-tuned to a predetermined position. A plurality of the corner fixed pieces are used again to fix the elevated floor 2 and to loose two of the third buckle 642 and a plurality of the third fine-tuning device 643 and the third elevating device 61 is raised again making the elevated floor 2 leave the conveying device 3 to perform processing.

The third fixed plate 65 and the third frame body 64 are a third spacing D3 apart. The third spacing D3 and the second spacing D2 as well as the first spacing may be the same or different. The third fixed plate 65 has a plurality of the third perforations 651 that provides the third milling cutter body 621 to pass through. The third milling cutter body 621 is connected to the third fixed plate 65 with a second fixed ring R2. The third milling cutter body 621 can be connected with a damper 622, a stroke adjuster 623, a first stroke contactor 625 and a second stroke contactor 626. A plurality of third perforations 651 are evenly distributed on the third fixed plate 65 and opposite to the position of the ejector pin 221. In addition, among the plurality of third perforations 651, the spacing between the centers of two adjacent third perforations 651 is greater than the diameter of the third milling cutter body 621.

The third transmission device 66 is connected to a plurality of the third milling cutter bodies 621 respectively to make the third milling cutter bodies 621 perform rotation. It should be noted that the third transmission device 66 includes a third power source 661 and a plurality of third belt sets 662. Through the supplying of power by the first power source 661, a plurality of third belt sets 662 can be mutually connected to perform rotation.

To further illustrate, the elevated floor 2 is displaced above the third elevating device 61, and the third elevating device 61 is used to push the elevated floor 2 away from the transport structure 33 from the first surface 21. The floor 2 is displaced from the transport structure 33 to the third height H3 apart, and in the mean time, the ribs 222 contact against one end of the third milling cutter set device 62.

That is to say, since the third milling cutter set device 62 is located at a position corresponding to the third elevating device 61, the third elevating device 61 is used to push the elevated floor 2 away from the transport structure 33 from the first surface 21. The transport structure 33 makes the ribs 222 of different heights to contact against the corresponding third milling cutter body 621 respectively, and the third milling cutter body 621 can perform milling operations on the corresponding ejector pins 221. In addition, the plurality of third milling cutter bodies 621, the plurality of second milling cutter bodies 521, and the plurality of first milling cutter bodies 421 respectively correspond to a plurality of different positions of the ejector pins 221.

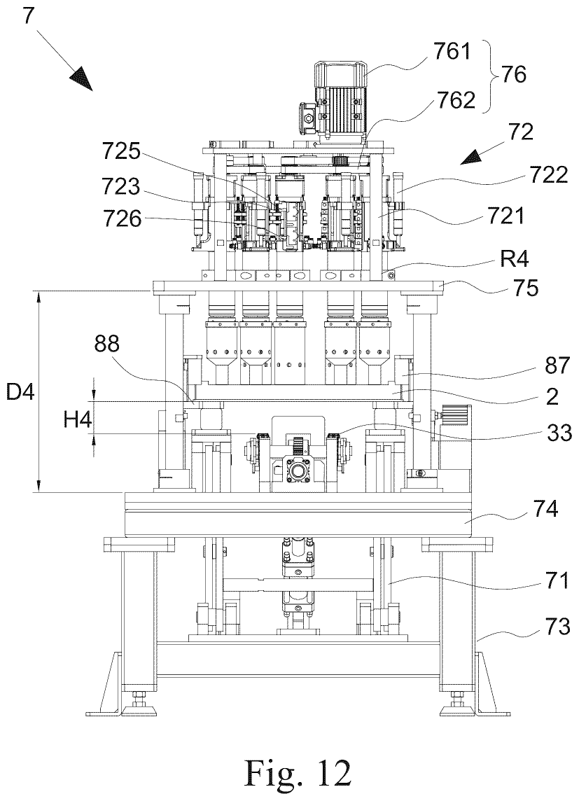

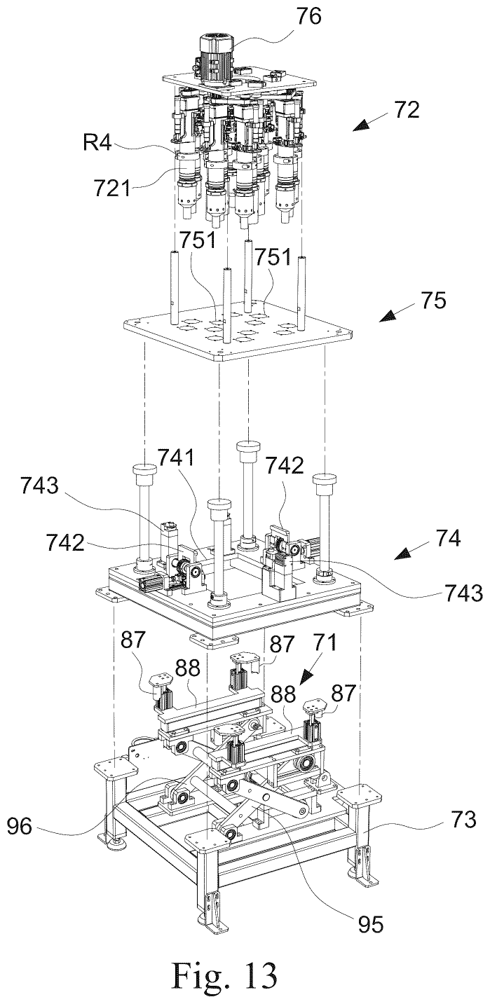

Referring to FIG. 12 and FIG. 13. The fourth milling cutter ejector pin device 7 is positioned between the third milling cutter ejector pin device 6 and the second frame 32, and the transport structure 33 passes through the fourth milling cutter ejector pin device 7 which includes: a fourth elevating device 71, a fourth milling cutter set device 72, a fourth pedestal 73, a fourth frame body 74, a fourth fixed plate 75 and a fourth transmission device 76.

The fourth elevating device 71 includes a first link device 95, a second link device 96 and a plurality of corner fixed pieces 87. Two of the corner fixed pieces 87 are provided above the first link device 95 and above the second link device 96 respectively. The first link device 95 and the second link device 96 are on both sides of the fourth elevating device 71 respectively. By the use of a plurality of round tubes to connect the first link device 95 and the second link device 96, and a pneumatic device or a hydraulic device (not shown in the Fig.) pushes one of the round tubes away, thereby driving the first link device 95 and the second link device 96 to raise or lower synchronously so as to push the elevated floor 2 away from the transport structure 33 and to be apart from the transport structure 33 by a spacing of a fourth height H4.

The fourth milling cutter set device 72, being located at a position corresponding to the fourth elevating device 71, has a plurality of fourth milling cutter bodies 721. The plurality of fourth milling cutter bodies 721 do not mutually interfere with one another. The four milling cutter bodies 721 are divided into several sets of barrel diameters according to the height of the ejector pin 221. The plurality of fourth milling cutter bodies 721, the plurality of third milling cutter bodies 621, the plurality of second milling cutter bodies 521 and the plurality of first milling cutter bodies 421 correspond with different positions of the a plurality of ejector pins 221 respectively.

The fourth pedestal 73 carries the fourth elevating device 71.

Both ends of the fourth frame body 74, being connected to the fourth pedestal 73 and the fourth milling cutter set device 72 respectively, has a fourth groove 741 which provides the fourth elevating device 71 to pass through.

In addition, in the first embodiment, the fourth frame body 74 also includes two fourth buckles 742 and a plurality of fourth fine-tuning devices 743. The fourth buckles 742 are provided on the fourth frame body 74 and adjacent to the two opposite sides of the fourth groove 741 in the traveling direction of the displacement movement 9. The fourth fine-tuning device 743 is in equal spacing provided on the other two opposite sides of the fourth groove 741.

It should be noted that when the elevated floor 2 is conveyed above the fourth groove 741, the fourth buckle 742 that is far away from the elevated floor 2 is flipped to the direction of travel in mutually perpendicular directions to stop on one side of the elevated floor 2. In the mean time, the other fourth buckle 742 is turned over and stops on the other side of the elevated floor 2 to position the elevated floor 2, and finally, make a support plate 88 of the fourth elevating device 71 push the elevated floor 2 away from the transport structure 33 and has a spacing of the fourth height H4 apart. Preferably, by the use the fourth fine-tuning device 743, the position of the elevated floor 2 is fin-tuned to adjust to a predetermined position, and by the use of the plurality of corner fixed pieces 87 again to fix the elevated floor 2 in position, and to loose and two of the fourth buckles 742 and a plurality of the fourth fine-tuning devices 743, and then to be raised by the fourth elevating device 71 so as to make the elevated floor 2 to leave the conveying device 3 for performing processing.

The fourth fixed plate 75 and the fourth frame body 74 are apart by a fourth spacing D4. The fourth fixed plate 75 has a plurality of fourth perforations 751 for providing the fourth milling cutter body 721 to pass through. The fourth milling cutter body 721, being connected to the fourth fixed plate 75 by a fourth fixed ring R4, can be connected with a damper 722, a stroke adjuster 723, and a first stroke contactor 725 and a second stroke contactor 726. The plurality of fourth perforations 751 are evenly distributed on the fourth fixed plate 75 and relative to the position of the ejector pin 221. In addition, among the plurality of fourth perforations 751, the spacing between the center of two adjacent fourth perforations 751 is greater than the diameter of the fourth milling cutter body 721.

The fourth transmission device 76 is connected to a plurality of the fourth milling cutter bodies 721 respectively making the fourth milling cutter bodies 721 perform rotation. It should be noted that the fourth transmission device 76 includes a fourth power source. 761 and a plurality of the fourth belt sets 762. The plurality of the fourth milling cutter bodies 721, being powered by the fourth power source 761, are mutually connected to the plurality of fourth belt sets 762 for performing rotation.

To further illustrate, the elevated floor 2, being displaced above the fourth elevating device 71, is pushed away from the transport structure 33 from the first surface 21 through the fourth elevating device 71. The elevated floor 2 is apart from the transport structure 33 with the fourth height H4. In the mean time, the ribs 222 are contacted against one end of the fourth milling cutter set device 72.

That is to say, since the fourth milling cutter set device 72, being located at a position corresponding to the fourth elevating device 71, the elevated floor 2 is pushed away from the conveying structure 33 from the first surface 21 by the use of the fourth elevating device 71, making the ribs 222 with different heights to contact against the corresponding fourth milling cutter body 721, and also making the fourth milling cutter body 721 can perform milling operations on the corresponding ejector pins 221. In addition, the plurality of fourth milling cutter bodies 721, the plurality of third milling cutter bodies 621, the plurality of second milling cutter bodies 521 and the plurality of first milling cutter bodies 421 are corresponding to the different plurality of ejector pins 221 respectively.

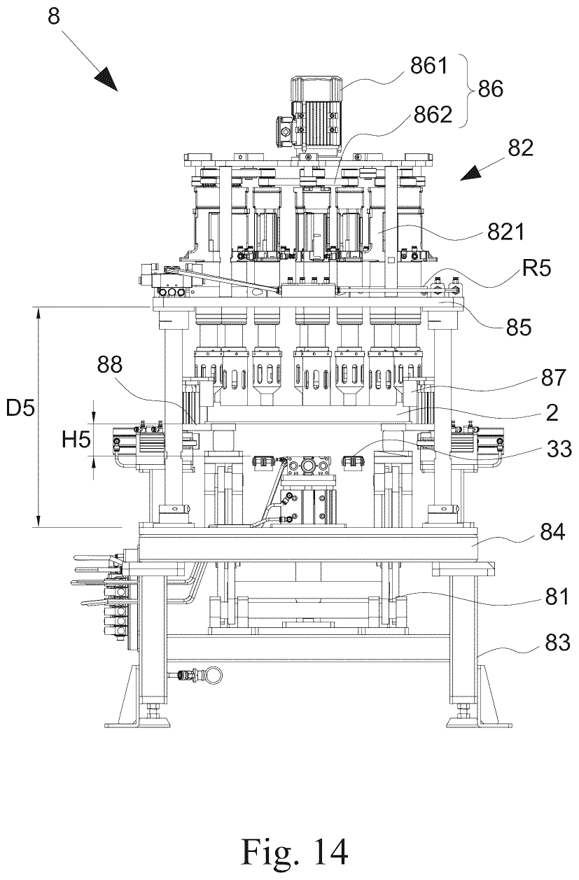

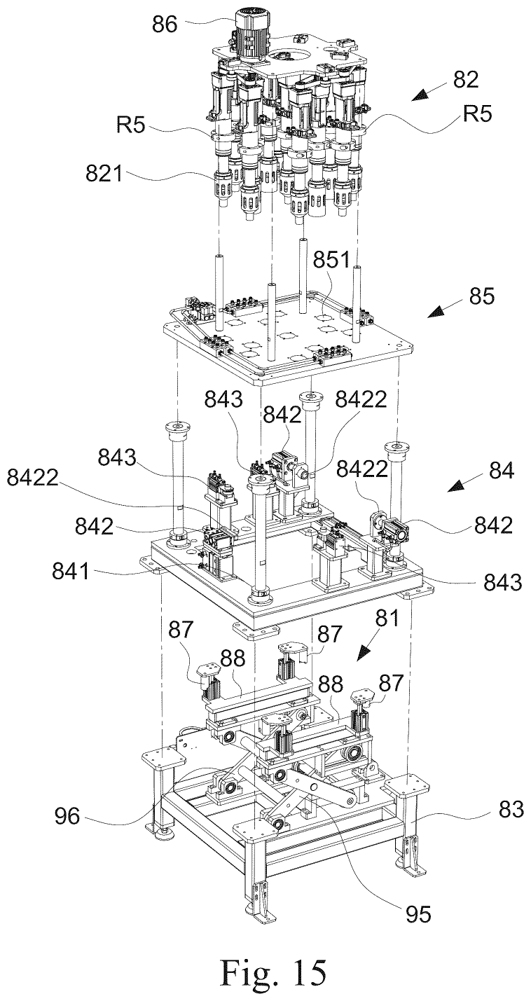

Referring to FIG. 14 through FIG. 16, the second embodiment of the milling cutter equipment for elevated floor 1 of the invention includes a fifth milling cutter ejector pin device 8, a sixth milling cutter ejector pin device 11, a seventh milling cutter ejector pin device 12 and an eighth milling cutter ejector pin device 13. These are the replacement devices of the first milling cutter ejector pin device 4, the second milling cutter ejector pin device 5, the third milling cutter ejector pin device 6 and the fourth milling cutter ejector pin device 7 respectively.

In addition, in the milling cutter equipment 1 for elevated floor in the second embodiment of the invention, by using the fifth milling cutter ejector pin device 8 as an example to describe the fifth milling cutter ejector pin device 8, the sixth milling cutter ejector pin device 11, the seventh milling cutter ejector pin device 12 and the eighth milling cutter ejector pin device 13. The structures of the sixth milling cutter ejector pin device 11, the seventh milling cutter ejector pin device 12 and the eighth milling cutter ejector pin device 13 are all the same as those of the fifth milling cutter ejector pin device 8, thereby it is understood clearly that they will not be described in detail here. Referring to FIG. 14 and FIG. 14, the fifth milling cutter ejector pin device 8 is positioned between the first frame 31 and the second frame 32, and the transport structure 33 passes through the fifth milling cutter ejector pin device 8. The ejector pin device 8 includes: a fifth elevating device 81, a fifth milling cutter set device 82, a fifth pedestal 83, a fifth frame body 84, a fifth fixed plate 85 and a fifth transmission device 86.

The fifth elevating device 81 includes a first link device 95, a second link device 96 and a plurality of corner fixed pieces 87 wherein two of a plurality of corner fixed pieces 87 are provided above the first link device 95 and the second link device 96 respectively. The first link device 95 and the second link device 96, being provided on the two sides of the fifth elevating device 81, are connected by a plurality of round tubes, and by the use of a pneumatic device or a hydraulic device (not shown in the Fig.) to push one of the round tubes, thereby to drive the first link device 95 and the second link device 96 to raise or lower synchronously to push the elevated floor 2 away from the transport structure 33 with a distance of a fifth height H5 apart.

The fifth milling cutter set device 82, being located at a position corresponding to the fifth elevating device 81, has a plurality of fifth milling cutter bodies 821. The plurality of fifth milling cutter bodies 821, being not interfere with one another, are divided into several sets of barrel diameters according to the height of the ejector pin 221. In addition, a plurality of fifth milling cutter bodies 821, a plurality of fourth milling cutter bodies 721, a plurality of third milling cutter bodies 621, a plurality of second milling cutter body 521, and a plurality of first milling cutter bodies 421 correspond to a plurality of different positions of the ejector pins 221 respectively.

The fifth pedestal 83 carries the fifth elevating device 81.

Both end of the fifth frame body 84, being connected to the fifth pedestal 83 and the fifth milling cutter set device 82 respectively, has a fifth groove 841 which provides the fifth elevating device 81 to pass through.

In addition, in this preferred embodiment, the fifth frame 84 also includes two fifth buckles 842 and a plurality of fifth fine-tuning devices 843. The fifth buckles 842, being provided on the fifth frame body 84, is adjacent to the two opposite sides of the fifth groove 841 in the traveling direction of the displacement movement 9. The fifth fine-tuning device 843 is in equal spacing provided on the other two opposite sides of the fifth groove 841.

It should be noted that when the elevated floor 2 is conveyed above the fifth groove 841, a support plate 88 of the fifth elevating device 81 is raised to bear the elevated floor 2. The fifth buckles 842 are relatively far apart from the elevated floor 2. By the use of control air pressure value, one of anti-collision baffles 8422 is extended out of the fifth buckles 842, and its extension direction is a direction mutually perpendicular to the direction of travel of the displacement movement 9, so that the anti-collision baffles 8422 stop on one side of the elevated floor 2. Preferably, the fifth fine-tuning device 843 is used to fine-tune the position of the elevated floor 2 at a predetermined position. In the mean time, by the use of the control air pressure value, the other pair of the fifth buckles 842 stop on the other two sides of the elevated floor 2 respectively. Finally, the four corner fixed plate 87 is used to position at the four corners of the elevated floor 2 respectively and fix the four corners of the elevated floor 2 with the four corner fixed pieces 87 respectively, and loosen the two fifth buckles 842 and the plurality of fifth fine-tuning devices 843 so that the fifth elevating device 81 pushes the elevated floor 2 away from the transport structure 33 at a spacing of the fifth height H5 apart. Finally, the elevated floor 2 is raised by the fifth elevating device 81 so that the elevated floor 2 leaves the conveying device 3 for performing processing.

The fifth fixed plate 85, being apart from the fifth frame body 84 by a fifth spacing D5, has a plurality of fifth perforations 851 which provide the fifth milling cutter bodies 821 to pass through. The fifth milling cutter bodies 821 are connected to the fifth fixed plate 85 by the use of the fifth fixed rings R5. A plurality of fifth perforations 851 are distributed on the fifth fixed plate 85 relative to the positions of the ejector pins 221. In addition, among the plurality of fifth perforations 851, the spacing between the centers of two adjacent fifth perforations 851 is greater than the diameters of the fifth milling cutter bodies 821.

As shown in FIG. 14, the fifth transmission device 86 is connected to a plurality of fifth milling cutter bodies 821 respectively to make the fifth milling cutter bodies 821 perform rotation. It should be noted that the fifth transmission device 86 includes a fifth power source. 861 and a plurality of fifth belt sets 862. A plurality of fifth milling cutter bodies 821, being provided power through the fifth power source 861, are mutually connected to a plurality of fifth belt sets 862 to perform rotation.

As shown in FIG. 14, to further explain, the elevated floor 2 is displaced above the fifth elevating device 81, and the fifth elevating device 81 is used to push the elevated floor 2 away from the transport structure 33 from the first surface 21. The elevated floor 2 is displaced from the transport structure 33 at a spacing of the fifth height H5 apart. In the mean time, the ribs 222 are contacted against one end of the fifth milling cutter set device 82.

That is to say, since the fifth milling cutter set device 82 is located at a position corresponding to the fifth elevating device 81, the fifth elevating device 81 is used to push the elevated floor 2 away from the transport structure 33 from the first surface 21 making the ribs 222 of different heights to contact against the corresponding fifth milling cutter body 821 respectively, and the fifth milling cutter body 821 can perform milling operations on the corresponding ejector pins 221. In addition, the plurality of fifth milling cutter bodies 821 and the plurality of first milling cutter bodies 421 may correspond to the different or the same positions of the plurality of ejector pins 221 respectively.

It should be noted that, in the above content, the first height H1, the second height H2, the third height H3, the fourth height H4 and the fifth height H5 may be the same or different from one another different heights. In addition, the first spacing D1, the second spacing D2, the third spacing D3, the fourth spacing D4 and the fifth spacing D5 may be the same or different spacings from one another.

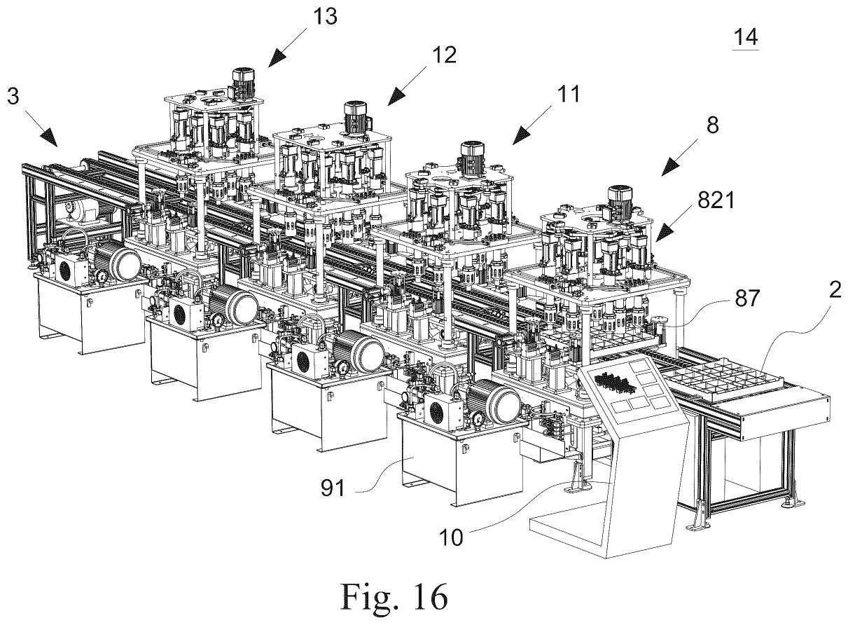

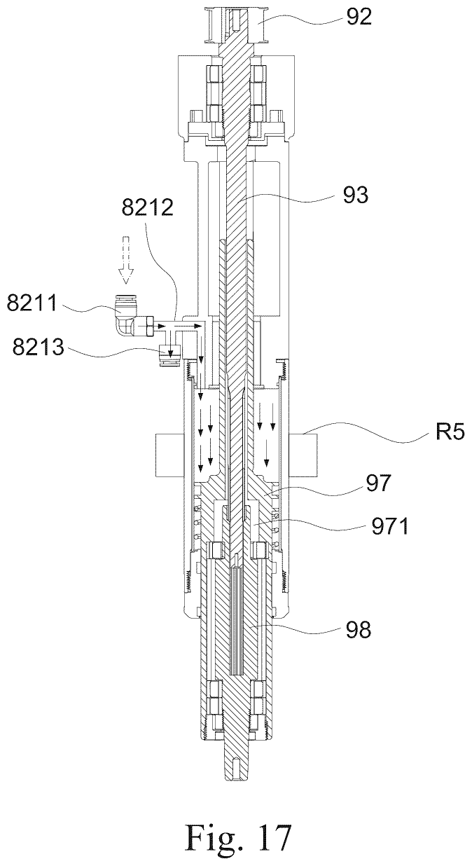

Referring to FIG. 16 and FIG. 17, in this second embodiment, the fifth milling cutter body 821, a sixth milling cutter body, a seventh milling cutter body and an eighth milling cutter body can be actuated through a control device 91 respectively. The control device 91 can be a hydraulic control device or a pneumatic control device, the sixth milling cutter body, the seventh milling cutter body, and the eighth milling cutter body are all the same as the fifth milling cutter body 821, thereby it is understood clearly that they will not be described in detail here.

That is to say, when starting to handle the milling operation, the fifth transmission device 86 makes the first milling cutter body 421 to perform rotational milling cutting, and by the use of the control device 91 to control the fifth milling cutter body 821 to conduct the depth of milling. The milling operation process further has a sixth transmission device, a seventh transmission device and an eighth transmission device. The sixth transmission device, the seventh transmission device and the eighth transmission device are all the same as the fifth transmission device 86. Thereby, it is understood clearly that they will not be described in detail here. The sixth transmission device makes the six milling cutter body to perform rotational milling cutting and by the use of the control device 91 to control the sixth milling cutter body to conduct the depth of milling. The seventh transmission device makes the seven milling cutter body to perform rotational milling cutting, and by the use of the control device 91 to control the seventh milling cutter body to conduct the depth of milling. The eighth transmission device makes the eighth milling cutter body to perform rotational milling cutting, and by the use of the control device 91 to control the eighth milling cutter body to conduct the depth of milling.

Referring to FIG. 16. In addition, the milling cutter equipment of the elevated floor 14 further includes a human-machine interface control platform 10. By the use of the human-machine interface control platform 10, one can use the way of entering the processing value by a programmable logic controller (PLC). The human-machine interface control platform 10, the conveying device 3, the fifth milling cutter ejector pin device 8, the sixth milling cutter ejector pin device 11, the seventh milling cutter ejector pin device 12, the eighth milling cutter ejector pin device 13 and the control devices 91 are all mutually in electrical and communicative connection to control the operation of the milling cutter equipment of elevated floor 14.

In addition, referring to FIG. 17. The main difference between the above two embodiments is that the milling cutter equipment for elevated floor 1 in the second embodiment does not need to use the damper, the stroke adjuster and the stroke contactor. That is to say, in the second embodiment, because a back pressure exhaust valve 8213 which connected to back pressure exhaust valve control device, adding at an air inlet flow channel 8212 connected to the air inlet valve 8211 of the fifth milling cutter body 821. In this way, by the use of the control air pressure, there is no need to use the damper 522, the stroke adjuster 523, the first stroke contactor 525 and the second stroke contactor 526. Also, when the back pressure exhaust pressure of the back pressure exhaust valve 8213 is set at 5 to 6.5 kg per square centimeter, the vibration of the fifth milling cutter body 821 can be reduced, and the manufacturing cost can be reduced too. That is to say, during the performing operation, when the back pressure exhaust pressure of the back pressure exhaust valve 8213 is preset to be greater than the intake pressure, if anything happen that the intake pressure is greater than the setting value the back pressure exhaust pressure, gas is discharged from the back pressure exhaust valve 8213 after the gas enters from the air inlet flow channel 8212. Thereby, this kind of defects of excessive surface pressure can be avoided in the elevated floor 2, thereby reducing the vibration of the fifth milling cutter body 821, and the costs of manufacturing can be reduced.

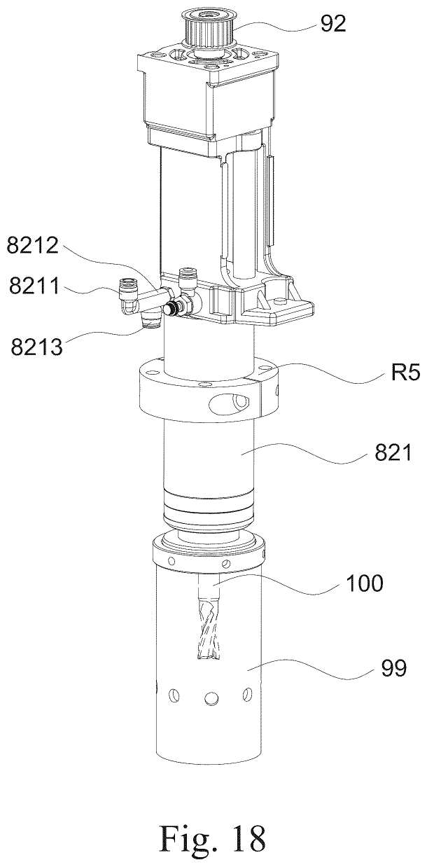

Referring to FIG. 17 and FIG. 18, which are schematic structural diagrams and partial cross-sectional views of the fifth milling cutter body 821. The fifth milling cutter body 821 includes a synchronous wheel 92, a spline 93, and a push rod 97, a spindle 98, a sleeve 99 and a milling cutter 100. The push rod 97 has a first accommodating space 971, and the spindle 98 is positioned in the first accommodating space 971. The sleeve 99, being a hollow structure, is mutually and movably connected to the spline 93. The milling cutter 100 being connected to the spindle 98, is positioned in the sleeve 99. The synchronizing wheel 92 drives the spline 93 to perform rotation.

In summary, the invention, being a milling cutter equipment for elevated floors, has the following features:

Utilizing the milling cutter equipment for elevated floor provided by the invention, by the use of arranging a plurality of milling cutter bodies into a state that a plurality of milling cutter set devices are not interfere with one another and combining the conveying device to form the way of an automatic process to have the ejector pins of the elevated floor perform milling cutting respectively so as to speed up the production process and to improve production efficiency while reducing manpower requirements.

The above embodiments are only used to illustrate the technical solution of the invention rather than to limit it. Although the invention is described in detail with reference to the preferred embodiments, those of ordinary skill in the art should understand that the technical solutions of the invention can be modified or modified equivalent substitution without departing from the spirit and scope of this technical solution.

What is claimed is:

1. A milling cutter equipment for elevated floor comprising:
a conveying device further comprising a first frame, a second frame and a transport structure wherein the transport structure, being positioned between the first frame and the second frame, performs a displacement movement and can carry a plurality of elevated floors.
a first milling cutter ejector pin device is positioned between the first frame and the second frame, and makes the transmission structure to pass through the first milling cutter ejector pin device and the first milling cutter ejector pin device further comprising:
a first elevating device further comprising four corner fixed piece, and the four corner fixed piece fix the four corresponding corners of the elevated floor respectively to push the elevated floor away from the transmission structure with a spacing at a first height apart; and
a first milling cutter set device, being positioned at a position corresponding to the first elevating device, has a plurality of first milling cutter bodies wherein the plurality of first milling cutter bodies do not interfere with one another, and wherein the plurality of first milling cutter bodies are divided into several sets of barrel diameters according to the heights of rib of the elevated floor; and
a second milling cutter ejector pin device is positioned between the first frame and the second frame, and makes the transmission structure to pass through the second milling cutter ejector pin device and the second milling cutter ejector pin device further comprising:
a second elevating device further comprising four corner fixed piece, and the four corner fixed piece fix the four corresponding corners of the elevated floor respectively to push the elevated floor away from the transmission structure with a spacing at a second height apart; and
a second milling cutter set device, being positioned at a position corresponding to the second elevating device, has a plurality of second milling cutter bodies wherein the plurality of second milling cutter bodies do not interfere with one another, and wherein the plurality of second milling cutter bodies are divided into several sets of barrel diameters according to the heights of the ejector pin of the elevated floor.

2. The milling cutter equipment for the elevated floor as claimed in claim 1, wherein the transport structure comprising a main frame, a chain set, a first gear set and a second gear set, and both ends of the main frame are connected to the first gear set and the second gear set respectively, and the chain set is connected to the first gear set and the second gear set respectively, so that when the first gear set and the second gear set rotate synchronously, the chain set perform the displacement movement; the chain set comprising a guide strip and a chain wherein the guide strip is provided at two opposite outside edges while a bearing portion of the chain performs the displace movement along a guide groove of the guide strip respectively, and a roller and a shaft of the chain rolls on a sliding surface of the guide strip respectively to perform the displace movement.

3. The milling cutter equipment for the elevated floor as claimed in claim 2, wherein the conveying device further comprising a motor, which being set up on the second frame, is connected to the second gear set through a driving chain making the motor drives the second gear set to rotate.

4. The milling cutter equipment for elevated floor as claimed in claim 1, wherein the first milling cutter ejector pin device further comprising:
a first pedestal carrying the first elevating device;
a first frame body, both ends of the first frame body are connected to the first pedestal and the first milling cutter set device respectively, the first frame body has a first groove which provides the first elevating device to pass through;
a first fixed plate, being a first spacing apart from the first frame body, has a plurality of first perforations, wherein the first perforations provide the first milling cutter body to pass through, and wherein the first milling cutter bodies are connected to the first fixed plates by the use of the first fixed rings; and
a first transmission device connected to a plurality of the first milling cutter bodies respectively to make the first milling cutter bodies perform rotation;
the second milling cutter ejector pin device further comprising:
a second pedestal carrying the second elevating device;
a second frame body, both ends of the second frame body are connected to the second pedestal and the second milling cutter set device respectively, the second frame body has a second groove which provides the second elevating device to pass through;
a second fixed plate, being a second spacing apart from the second frame body, has a plurality of second perforations, wherein the second perforations provide the second milling cutter body to pass through, and wherein the second milling cutter bodies are connected to the second fixed plates by the use of the second fixed rings; and
a second transmission device connected to a plurality of the second milling cutter bodies respectively to make the second milling cutter bodies perform rotation.

5. The milling cutter equipment for the elevated floor as claimed in claim 1, wherein the milling cutter equipment for the elevated floor further comprising a third milling cutter ejector pin device and a fourth milling cutter ejector pin device, wherein the third milling cutter ejector pin device, being positioned between the second milling cutter ejector pin device and the second frame, makes the transmission structure to pass through, wherein the third milling cutter ejector pin device comprise:
a third elevating device, further comprising a four corner fixed piece which fix the corresponding four corners of the elevated floor respectively to push the elevated floor away from the transmission structure at a spacing of the third height apart; and
a third milling cutter set device, being located at a position corresponding to the third elevating device, has a plurality of third milling cutter bodies which do not interfere with one another, and the plurality of third milling cutter bodies are divided into several sets of barrel diameter according to the heights of the ejector pins respectively, what is more, the plurality of third milling cutter bodies, the plurality of second milling cutter bodies and the plurality of first milling cutter bodies correspond to the plurality of different positions of ejector pin respectively;
the fourth milling cutter ejector pin device, being positioned between the third milling cutter ejector pin device and the second frame, makes the transmission structure to pass through, wherein the fourth milling cutter ejector pin device comprise:
a fourth elevating device, further comprising a four corner fixed piece which fix the corresponding four corners of the elevated floor respectively to push the elevated floor away from the transmission structure at a spacing of the fourth height apart; and
a fourth milling cutter set device, being located at a position corresponding to the fourth elevating device, has a plurality of fourth milling cutter bodies which do not interfere with one another, and the plurality of fourth milling cutter bodies are divided into several sets of barrel diameter according to the heights of the ejector pins respectively, what is more, the plurality of fourth milling cutter bodies, the plurality of third milling cutter bodies, the plurality of second milling cutter bodies and the plurality of first milling cutter bodies correspond to the plurality of different positions of ejector pin respectively.

6. The milling cutter equipment for elevated floor as claimed in claim 5 wherein the third milling cutter ejector pin device further comprising:
a third pedestal carrying the third elevating device;
a third frame body, both ends of the third frame body are connected to the third pedestal and the third milling cutter set device respectively, the third frame body has a third groove which provides the third elevating device to pass through;
a third fixed plate, being a third spacing apart from the third frame body, has a plurality of third perforations, wherein the third perforations provide the third milling cutter body to pass through, and wherein the third milling cutter bodies are connected to the third fixed plates by the use of the third fixed rings; and
a third transmission device connected to a plurality of the third milling cutter bodies respectively to make the third milling cutter bodies perform rotation; and
the fourth milling cutter ejector pin device further comprising:
a fourth pedestal carrying the fourth elevating device;
a fourth frame body, both ends of the fourth frame body are connected to the fourth pedestal and the fourth milling cutter set device respectively, the fourth frame body has a fourth groove which provides the fourth elevating device to pass through;
a fourth fixed plate, being a fourth spacing apart from the fourth frame body, has a plurality of fourth perforations, wherein the fourth perforations provide the fourth milling cutter body to pass through, and wherein the fourth milling cutter bodies are connected to the fourth fixed plates by the use of the fourth fixed rings; and
a fourth transmission device connected to a plurality of the fourth milling cutter bodies respectively to make the fourth milling cutter bodies perform rotation.

7. The milling cutter equipment for the elevated floor as claimed in claim 5, wherein the first milling cutter body, the second milling cutter body, the third milling cutter body and the fourth milling cutter body are actuated by a control device which is a hydraulic control device or a pneumatic control device.

8. The milling cutter equipment for elevated floor as claimed in claim 7, further comprising a human-machine interface control platform, wherein the human-machine interface control platform, the conveying device, and the first milling cutter ejector pin device, the second milling cutter ejector pin device, the third milling cutter ejector pin device, the fourth milling cutter ejector pin device and the control device are all mutually in electrical and communicative connection to control the operation of the milling cutter equipment of elevated floor.

9. The milling cutter equipment for elevated floor of claim 1, wherein the first elevating device comprising a first link device, a second link device and a plurality of corner fixing pieces, wherein two of the plurality of corner fixing pieces are positioned above the first link device and the second link device, also the first link device and the second device are positioned on the two sides of the first elevating device respectively, moreover, by the use of a plurality of round tubes to connect the first link device and the second device and also by the use of a pneumatic device or a hydraulic device to push one of the round tubes, thereby driving the first link device and the second link device to raise or lower the first link device and the second link device synchronously so as to push the elevated floor away from the transport structure.

10. The milling cutter equipment for elevated floor of claim 1, wherein the second elevating device comprising a first link device, a second link device and a plurality of corner fixing pieces, wherein two of the plurality of corner fixing pieces are positioned above the first link device and the second link device, also the first link device and the second device are positioned on the two sides of the second elevating device respectively, moreover, by the use of a plurality of round tubes to connect the first link device and the second device and also by the use of a pneumatic device or a hydraulic device to push one of the round tubes, thereby driving the first link device and the second link device to raise or lower the first link device and the second link device synchronously so as to push the elevated floor away from the transport structure.

11. The milling cutter equipment for elevated floor of claim 5, wherein the third elevating device comprising a first link device, a second link device and a plurality of corner fixing pieces, wherein two of the plurality of corner fixing pieces are positioned above the first link device and the second link device, also the first link device and the second device are positioned on the two sides of the third elevating device respectively, moreover, by the use of a plurality of round tubes to connect the first link device and the second device and also by the use of a pneumatic device or a hydraulic device to push one of the round tubes, thereby driving the first link device and the second link device to raise or lower the first link device and the second link device synchronously so as to push the elevated floor away from the transport structure.

12. The milling cutter equipment for elevated floor of claim 1, wherein the fourth elevating device respectively comprising a first link device, a second link device and a plurality of corner fixing pieces, wherein two of which are provided above the first link device and the second link device, moreover, the first link device and the second link device are respectively on both sides of the fourth elevating device, and by the use of a plurality of round tubes to connect the first link device and the second link device, and a pneumatic device or a hydraulic device pushes one of the round tubes, thereby driving the first link device and the second link device to raise or lowered synchronously to push the elevated floor away from the conveyor structure.

13. The milling cutter equipment for elevated floor as claimed in claim 1, wherein the first milling cutter body comprising a synchronous wheel, a spline, a push rod, a spindle, a sleeve and a milling cutter, wherein the push rod has a first accommodation space, the spindle is positioned in the first accommodation space, the sleeve is a hollow structure and is movably and mutually connected to each other with splines, the milling cutter is connected to the spindle, and the milling cutter is positioned in the first accommodation space, and wherein the milling cutter is positioned in the sleeve while the synchronous wheel drives the spline to perform rotation.

14. The milling cutter equipment for elevated floor as claimed in claim 1, wherein the second milling cutter body comprising a synchronous wheel, a spline, a push rod, a spindle, a sleeve and a milling cutter, wherein the push rod has a first accommodation space, the spindle is positioned in the first accommodation space, the sleeve is a hollow structure and is movably and mutually connected to each other with splines, the milling cutter is connected to the spindle, and the milling cutter is positioned in the first accommodation space, and wherein the milling cutter is positioned in the sleeve while the synchronous wheel drives the spline to perform rotation.

15. The milling cutter equipment for elevated floor as claimed in claim 1, wherein the third milling cutter body comprising a synchronous wheel, a spline, a push rod, a spindle, a sleeve and a milling cutter, wherein the push rod has a first accommodation space, the spindle is positioned in the first accommodation space, the sleeve is a hollow structure and is movably and mutually connected to each other with splines, the milling cutter is connected to the spindle, and the milling cutter is positioned in the first accommodation space, and wherein the milling cutter is positioned in the sleeve while the synchronous wheel drives the spline to perform rotation.

16. The milling cutter equipment for elevated floor as claimed in claim 1, wherein the fourth milling cutter body comprising a synchronous wheel, a spline, a push rod, a spindle, a sleeve and a milling cutter, wherein the push rod has a first accommodation space, the spindle is positioned in the first accommodation space, the sleeve is a hollow structure and is movably and mutually connected to each other with splines, the milling cutter is connected to the spindle, and the milling cutter is positioned in the first accommodation space, and wherein the milling cutter is positioned in the sleeve while the synchronous wheel drives the spline to perform rotation.

17. The milling cutter equipment for the elevated floor as claimed in claim 4, wherein the first frame body further comprising two buckles and a plurality of fine-adjustment devices, and the two buckles are provided adjacent to two opposite sides of each groove respectively, also the two opposite sides are positioned in the direction of the displacement movement, what is more, a plurality of the fine-tuning devices are positioned in equal spacing on the other two opposite sides of each groove respectively.

18. The milling cutter equipment for the elevated floor as claimed in claim 4, wherein the second frame body further comprising two buckles and a plurality of fine-adjustment devices, and the two buckles are provided adjacent to two opposite sides of each groove respectively, also the two opposite sides are positioned in the direction of the displacement movement, what is more, a plurality of the fine-tuning devices are positioned in equal spacing on the other two opposite sides of each groove respectively.

19. The milling cutter equipment for the elevated floor as claimed in claim 4, wherein the third frame body further comprising two buckles and a plurality of fine-adjustment devices, and the two buckles are provided adjacent to two opposite sides of each groove respectively, also the two opposite sides are positioned in the direction of the displacement movement, what is more, a plurality of the fine-tuning devices are positioned in equal spacing on the other two opposite sides of each groove respectively.

20. The milling cutter equipment for the elevated floor as claimed in claim 4, wherein the fourth frame body further comprising two buckles and a plurality of fine-adjustment devices, and the two buckles are provided adjacent to two opposite sides of each groove respectively, also the two opposite sides are positioned in the direction of the displacement movement, what is more, a plurality of the fine-tuning devices are positioned in equal spacing on the other two opposite sides of each groove respectively.
